(19) United States
(12) Patent Application Publication
(10) Pub. No.: US 2009/0213079 A1
(43) Pub. Date: Aug. 27, 2009

(54) Multi-Purpose Input Using Remote Control

(75) Inventors: Todd D. Segal, Seattle, WA (US); David L. Franklin, Seattle, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/037,550

(22) Filed: Feb. 26, 2008

(51) Int. Cl. G06F 3/02

(52) U.S. Cl. 345/169

(57) ABSTRACT

Systems and methods for inputting text and commands to an electronic device using a remote control device. One method includes displaying a first grid on a display device, wherein at least one cell in the first grid represents alphanumeric characters and at least one cell represents an operation function. The method includes receiving a first input from the remote control device that identifies a first cell that includes first alphanumeric characters, and displaying a second grid in front of the first grid such that the second grid including a plurality of cells, with each cell representing the first alphanumeric characters. The method also includes receiving a second input from the remote control device that identifies a specific alphanumeric character within the second grid, and displaying the identified alphanumeric character on the display device.

### BACKGROUND

Due to evolving television-based technologies, such as interactive television and web TV, there is an increased need to enter text into set top boxes or other electronic devices connected to television sets. The current method of text entry using remote control devices can be cumbersome. Typically, the user is presented with a virtual on-screen keyboard or an up/down scroll control in which the user can select letters via remote control to enter into a text box. These methods typically require an average of more than 5 keystrokes to enter a character.

Two current methods for text entry using a numeric keypad are multi-tap and T9. With multi-tap, a key corresponding to a character is pressed one or more times depending on the position of the character on the key. For example, on a typical remote control, the letters A, B, and C are associated with the 2 key. In order to enter the letter B, the 2 key is pressed two times because the letter B is the second letter in the A, B, C set.

With T9, a key associated with a letter is only pressed once. Then, as additional keys are pressed, the input device infers which letters are desired. For example, if the 8 key, 4 key and 3 key are pressed in succession, the device infers that the word “the” is to be entered. A second aspect of T9 is that as additional keys are pressed, the number of words corresponding to those key presses is reduced and the input device may provide a selection of words corresponding to those key presses. If the selection contains the word the user is trying to enter, the user can select the word with a single keystroke.

### SUMMARY

The present disclosure relates to systems and methods for inputting text and commands to an electronic device using a remote control device.

According to one aspect, a method for inputting text and commands to an electronic device using a remote control device includes: displaying a first grid on a display device, wherein at least one cell in the first grid represents alphanumeric characters and at least one cell represents an operation function; receiving a first input from the remote control device that identifies a first cell that includes first alphanumeric characters; displaying a second grid in front of the first grid such that the second grid including a plurality of cells, with each cell representing the first alphanumeric characters; receiving a second input from the remote control device that identifies a specific alphanumeric character within the second grid; and displaying the identified alphanumeric character on the display device.

According to another aspect, a method for inputting text and commands to a set top box using a remote control device includes: displaying a first grid on a television display screen, wherein six cells of the first grid include alphanumeric characters and at least one cell represents an operation function; receiving a first input from the remote control device that identifies a first cell of the first grid that includes first alphanumeric characters; displaying a second grid on the television display screen in front of the first grid such that the second grid including a plurality of cells, with each cell representing the first alphanumeric characters; receiving a second input from the remote control device that identifies a specific alphanumeric character within the second grid; displaying the specific alphanumeric character on the television display screen; receiving a third input from the remote control device that identifies an operation function; and executing the operation function identified by the third input.

According to yet another embodiment, an electronic device for inputting text and commands using a remote control device includes a virtual keyboard module programmed to display a virtual keyboard on a display device, the virtual keyboard including a first grid with at least some cells displaying a plurality of alphanumeric characters, and at least some cells display function operations. The electronic device includes a remote device input module programmed to receive input to the virtual keyboard from the remote control device. The electronic device also includes a text and operation output module programmed to, upon selection of a cell of the first grid: display a second grid including a plurality of cells each with one of a plurality of alphanumeric characters associated with the selected cell of the first grid; or execute an function operation associated with the selected cell of the first grid. The electronic device includes a memory module programmed to store the virtual keyboard module, the remote device input module, and the text and operation output module.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

The accompanying drawings incorporated in and forming a part of the specification illustrate several aspects of the present disclosure, and together with the description serve to explain the principles of the disclosure. In the drawings:

FIG. 1 shows an example system for entering text into an electronic device using a remote control device.

FIG. 2 shows an example keypad of the remote control device of FIG. 1.

FIG. 3 shows logical modules of the electronic device of FIG. 1.

FIG. 4 shows an example virtual on-screen keyboard that can be used when entering text into an electronic device.

FIG. 5 shows an example enlarged grid of a virtual on-screen keyboard that can be used when entering text into an electronic device.

FIG. 6 shows another example virtual on-screen keyboard that can be used when entering text into an electronic device.

FIG. 7 shows another example enlarged grid of a virtual on-screen keyboard that can be used when entering text into an electronic device.

FIG. 8 shows an example virtual on-screen keyboard that can be used when entering numerical data into an electronic device.

FIG. 9 shows an example virtual on-screen keyboard that can be used when entering symbols into an electronic device.

FIG. 10 shows an example virtual on-screen keyboard that can be used for text messaging.

FIG. 11 shows an example enlarged grid of a virtual on-screen keyboard that can be used when entering text during text messaging.

FIG. 12 shows another example virtual on-screen keyboard that can be used for text messaging.

FIG. 13 shows an example virtual on-screen keyboard that includes additional options for text messaging.

FIG. 14 shows an example virtual on-screen keyboard that can be used when entering addresses into an electronic device.

FIG. 15 shows a flow chart for an example method for entering text into an electronic device using a remote control device.

FIG. 16 shows a flow chart for an example method for entering text into a set top box using a remote control device.

### DETAILED DESCRIPTION

The present application is directed to systems and methods for entering text into an electronic device connected to a display device, such as a television screen, using a remote control device. The present application is also directed to entering operation function commands into an electronic device from a remote control device.

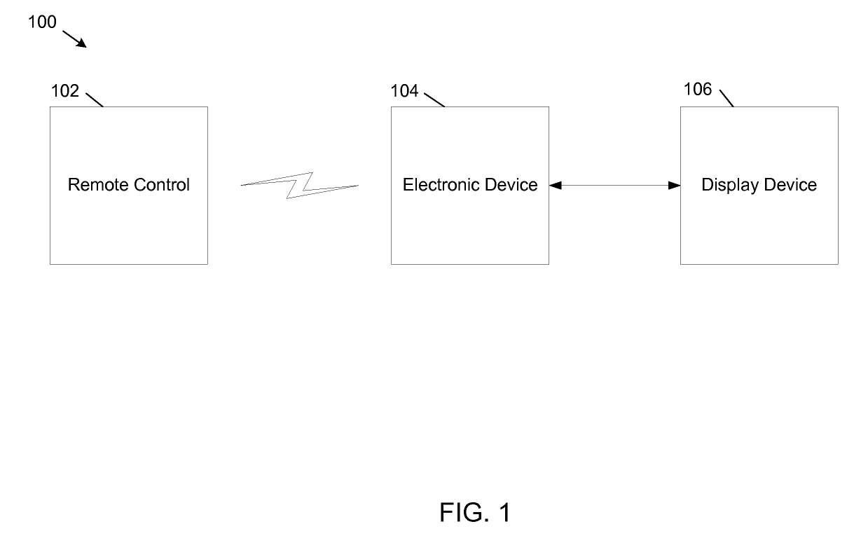

FIG. 1 shows an example system 100 for inputting text and commands into an electronic device using a remote control device. The example system 100 includes a remote control device 102, an electronic device 104, and a display device 106.

In example embodiments, the remote control device 102 is a device configured to control one or more of the electronic device 104 and the display device 106 using one or more wireless technologies. For example, the remote control device 102 can be a remote control that controls the electronic device 104 and/or the display device 106 using infrared, RF, or Bluetooth technologies. Other configurations are possible. For example, in other embodiments, the remote control device 102 can be connected to the electronic device 104 and/or the display device 106 using one or more wires.

The electronic device 104 is typically an electronic device that controls a display device, such as a television or computer monitor. For example, in some embodiments, the electronic device 104 is a cable or satellite TV set top box, a web TV box, a DVR or VCR, a digital picture frame, etc.

The display device 106 is typically a television screen, but it can be any display device, for example a computer monitor.

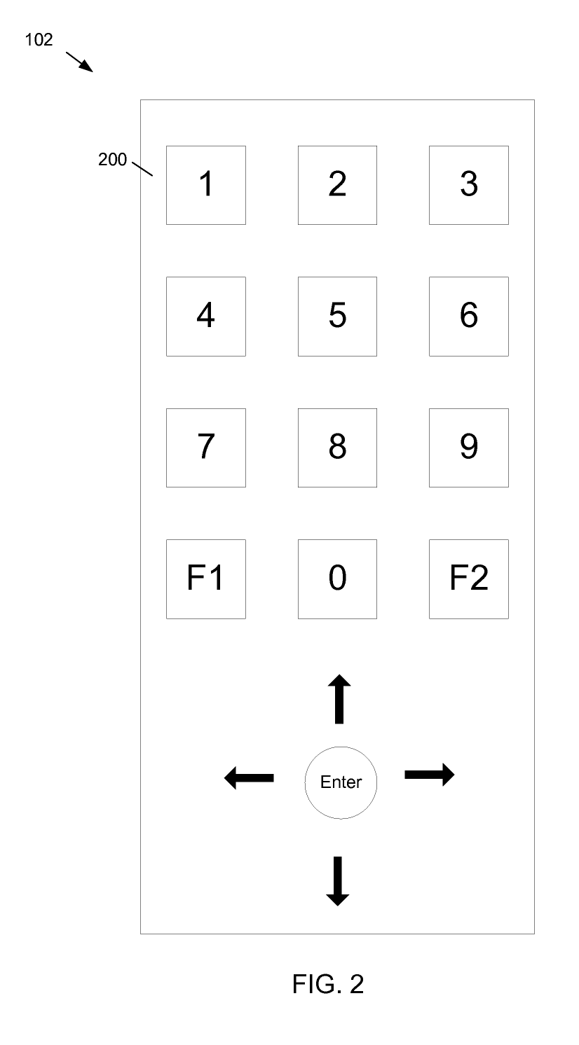

FIG. 2 shows an example an example keypad 200 of the remote control device 102. The example keypad 200 includes keys for the numbers 0-9. In some embodiments, the example keypad 200 also includes function keys, for example functions F1 and F2, and includes a directional pad with left, right, up, down arrow keys and an enter key. The function keys F1 and F2 may have the name of a function printed on the key—such as Enter. The user can push one or a combination of buttons on the keypad 200 to control one or both of the electronic device 104 and the display device 106. For example, the user can push number 0-9 to change channels displayed on the display device 106. The keypad 200 is one example of a remote control keypad. For example, some keyboards to not include function keys, and the functionality of such keys can instead be implemented as part of the user interface, as described further below. Many other configurations, including more keys and functionality, are possible.

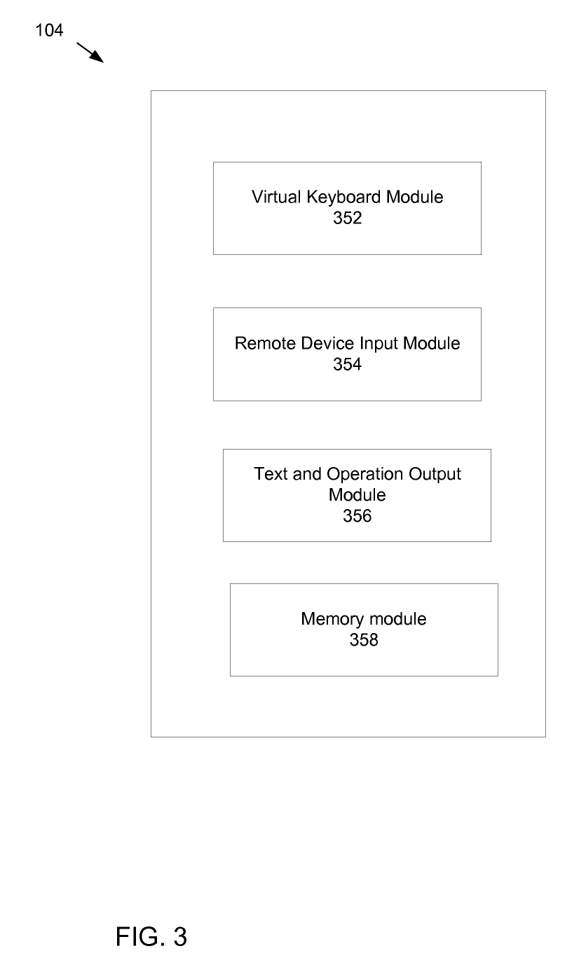

Referring now to FIG. 3, the logical modules of the electronic device 104 are shown. The electronic device 104 includes a virtual keyboard module 352, a remote device input module 354, a text and operation output module 356, and a memory module 358.

The virtual keyboard module 352 is programmed to create a virtual keyboard on the display device 106. In example embodiments, the virtual keyboard can be used to allow users to input text and/or function operations to the electronic device 104 or the display device 106, as described further below.

The remote device input module 354 is programmed to receive input from the remote control 102. In example embodiments, the electronic device 104 is configured to receive an input signal from the remote control 102, and this signal is provided to the remote device input module 354. In other examples, the display device 106 is configured to receive an input signal from the remote control 102, and this signal is provided to the remote device input module 354. Other configurations are possible.

The text and operation output module 356 is programmed to display text and/or perform function operations based on the input received by the remote device input module 354. For example, the text and operation output module 356 can be programmed to display text on the display device 106 based on the input received by the remote device input module 354. In addition, the text and operation output module 356 can be programmed to perform function operations based on the input received by the remote device input module 354, as described further below.

The memory module 358 is programmed to store data, such as the virtual keyboard module 352, the remote device input module 354, and the text and operation output module 356. In example embodiments, the memory module 358 is a computer readable media. Computer readable media can be any available media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, BC-ROM, digital versatile disks (DVD) or other optical storage, magnetic cassettes, magnetic tape, magnetic disk storage or other magnetic storage devices, or any other medium which can be used to store the desired information. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

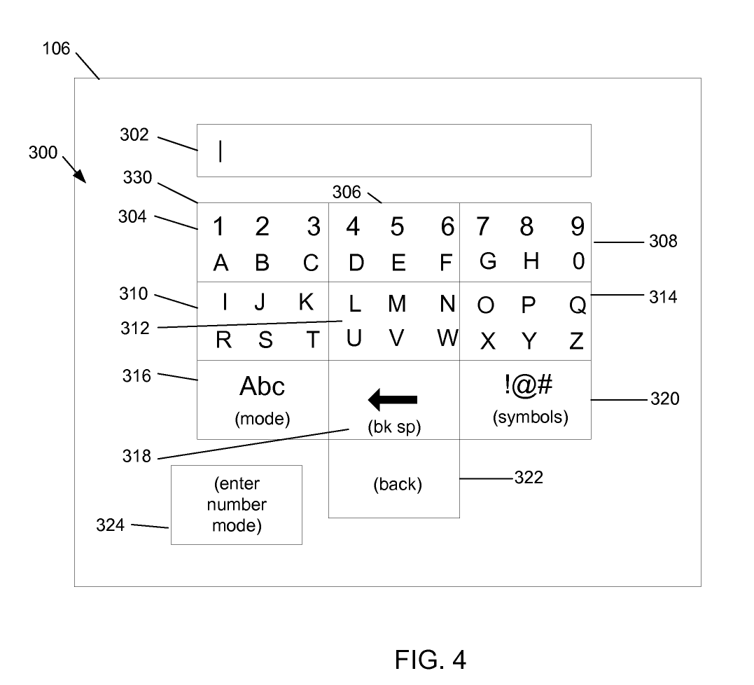

Referring now to FIG. 4, when text is inputted to an example electronic device using example system 100, the user is presented with a virtual on-screen keyboard 300 on the display device 106 that is used in conjunction with remote control device 102 for text and command entry.

In the example shown, the keyboard 300 includes a virtual on-screen keypad 330. The virtual on-screen keypad 330 is arranged as a grid with each cell in the grid associated with a number key on the remote control device 104. Included in the example virtual on-screen keyboard 330 are cells representing alphanumeric keys 304-314, symbols key 320 and function keys 316, 318, 322 and 324. Also included on example keyboard 330 is an example display area 302 that displays the characters selected.

In the example shown, each of the six example alphanumeric keys 304-314 includes six alphanumeric characters. For example, alphanumeric key 304 includes the numbers “1, 2, 3” and the letters “A, B, C.” The example symbols key 324 is identified by example symbols “!@#” and is used to enter punctuation and other symbols.

The example function keys 316, 318, 322 and 324 are identified by a specific operation function. Generally, the function keys are programmed to provide additional functionality to the input to the electronic device 104 or the display 106.

For example, example function key 316 selects a text entry mode, either upper case for the initial letter of a word and lower case for the remaining characters in the word, or all upper case or all lower case. Example function key 318 is used for a backspace function. Example function key 320 is used to select a numerical mode for text entry and example function key 322 is used to go back to the previous operation.

In other examples, one or more of the function keys can be used to provide auto completion or predictive text capabilities. For example, as the user inputs characters, completed words or phrases can be provided in the cells associated with the function keys so that the user can select a desired word or phrase to optimize the efficiency of text input. Other examples include using one or more of the function keys for text messaging or for entering HTML settings into the device, as described further below. It will be understood that the number and type of function keys shown on the keyboard 300 are just examples. Many other configurations are possible.

As shown in FIG. 4, the six example alphanumeric keys 304-316 correspond to the number keys 1-6 on a remote control device. For example, number key 1 on the remote control device corresponds to alphanumeric key 304, number key 2 corresponds to alphanumeric key 306, number key 3 corresponds to alphanumeric key 308, etc. going from left to right, top to bottom so that number key 6 corresponds to alphanumeric key 314. For example, if a user wanted to enter the letter A, the user would press number key 1 on the remote control because it corresponds to the cell 304 that includes the letter “A.”

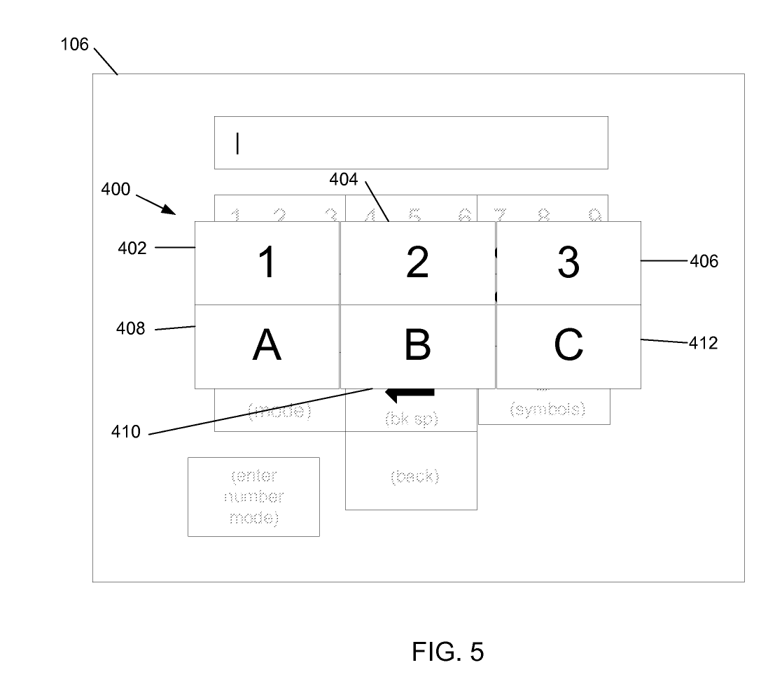

Referring now to FIG. 5, when a user presses a key on the remote control device 102 corresponding to one of cells 304-314 (i.e. one of the cells representing alphanumeric characters), the selected cell expands to display the alphanumeric characters in a separate grid. For example, when the user presses number key 1 on the remote control, the cell displaying alphanumeric key 304 expands to a grid 400 that overlays the keyboard 300. As shown in FIG. 5, each alphanumeric character from cell 304 is displayed in a separate cell 402-412 in the grid 400. Thus, the number 1 is displayed in cell 402 and the letter A is displayed in cell 408, etc.

The six example cells 402-412 shown in FIG. 5 are associated with number keys 1-6 on the remote control device. Going from left to right and top to bottom, number key 1 corresponds to cell 402, number key 2 corresponds to cell 404, number key 5 corresponds to cell 410, etc.

Therefore, when the expanded cells 402-412 are displayed, number key 1 on the remote control is pressed to select the number 1 in cell 402, number key 5 is pressed on the remote control to select the letter B in cell 410, etc. Thus, entering text is a two-step process. First, a cell corresponding to an alphanumeric key on the virtual on-screen keyboard is selected by pressing the remote control key associated with that cell. Then, when the cell expands to display another grid, as shown in FIG. 5, the specific alphanumeric character is selected by pressing the remote control number key associated with the expanded grid that displays the character. The cell expansion can make it easier for the user to see and select the desired character.

Referring again to FIG. 4, the example function keys 316 and 318, the example symbol key 320, and the example function key 322 correspond to remote control keys 7, 8, 9 and 0, respectively. In addition, example function key 324 corresponds to a specific function key on the remote control device (for example F1 or F2 shown in FIG. 2). So, for example, pressing number key 7 on the remote control device provides a command to execute the Abc mode command operation function 316. A typical way in which this command works is to toggle between three capitalization modes as discussed above. For example, pressing number key 7 once changes the mode to all lower case, pressing key 7 a second time changes the mode to all upper case and pressing key 7 a third time changes the mode to upper case for the initial character in a word and lower case for the remaining characters in the word. In some embodiments, the electronic device 104 causes the appearance of the operation function key to change to “abc,” “ABC,” and “Abc” for the three successive presses of number key 7.

Similarly, pressing number key “8” on the remote control device provides a command to an example back space function 318 and causes display 302 to backspace one position. Pressing number key “9” activates an example symbol key 320 and permits the user to enter a symbol. Pressing number key “0” on the remote control activates an example back function key 322 and causes electronic device 104 to go back to the previous operation. Function key 324 (for entering number mode) is associated with a function key (e.g. F1 or F2 in FIG. 2) on the remote control device.

Still referring to FIG. 4, in some embodiments, the cells associated with remote control device keys “7, 8, 9, 0” (corresponding to cells 316-322) are program specific and can be programmed by the electronic device 104 to represent different functions than those shown in FIG. 4. In some embodiments, the operation function cells can be programmed based on user selections. For example, in one embodiment, the user can program frequently-used phrases so that the phrases are displayed using the auto-complete feature, as described herein. Other embodiments that make use of user programmable features include text messaging and entering HTML settings.

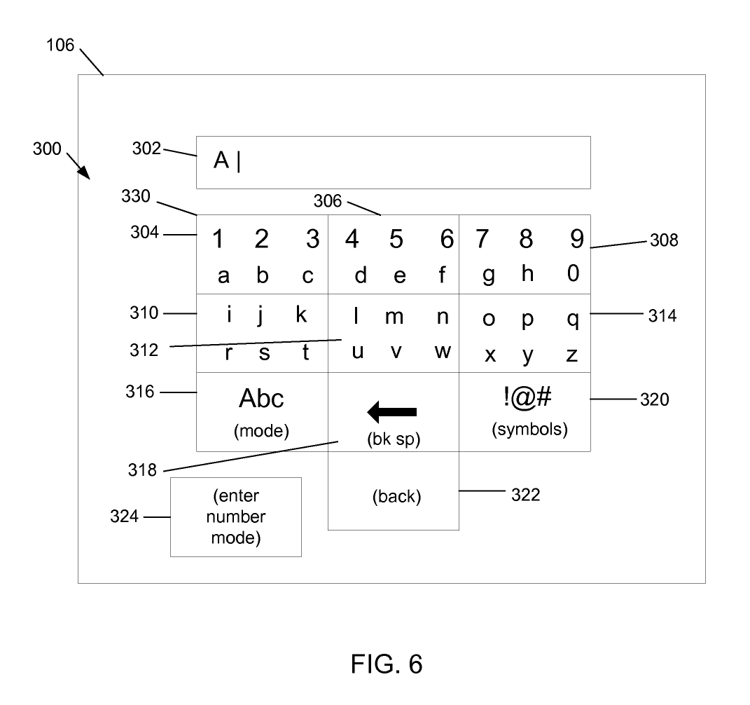

FIG. 6 shows how the keyboard 300 might look after the letter A has been entered. In this example, the display area 302 shows the letter “A.” Also, because the mode function key 316 indicates the mode as Abc, meaning an upper case letter for the first character in a word and lower case characters for the remaining characters in the word, the alphanumeric keys 304-314 are shown with lower case letters. In this example, the function keys 316, 318, 322 and 324 and the symbol key 320 have not changed.

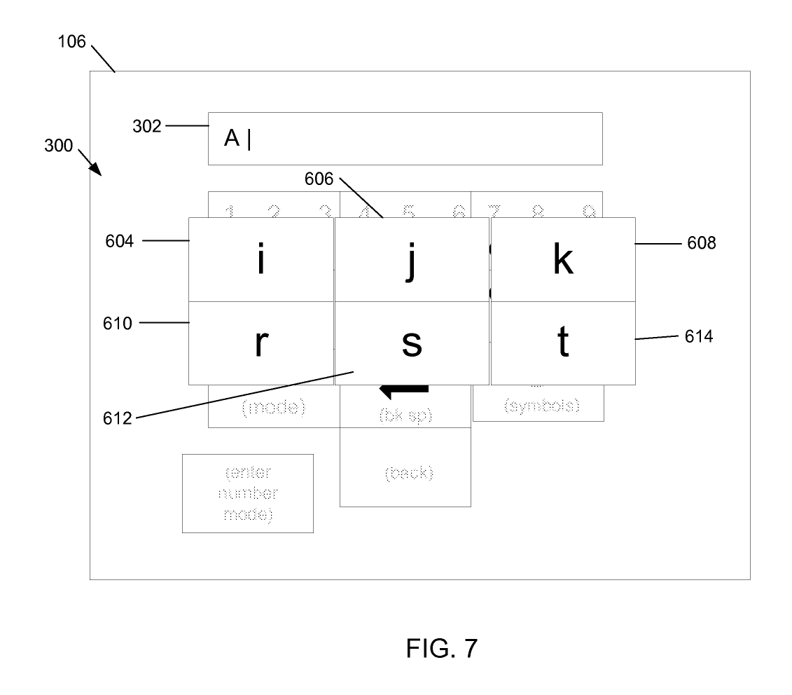

If a user now wants to enter the letter t, the user presses the number key 4 on the remote control device, since this corresponds to the cell on the keyboard 300 that includes the letters “i, j, k, r, s, t.” When the user enters the number key 4 on the remote control device, the cell containing these letters is expanded, as shown in FIG. 7. Each letter is now displayed in a separate cell 604-614 that corresponds to number keys 1-6 on the remote control device. If the user now presses number key 6 on the remote control device, the letter “t” is selected for display, since the letter “t” is the sixth alphabetic character cell shown in FIG. 7 going from left to right and top to bottom.

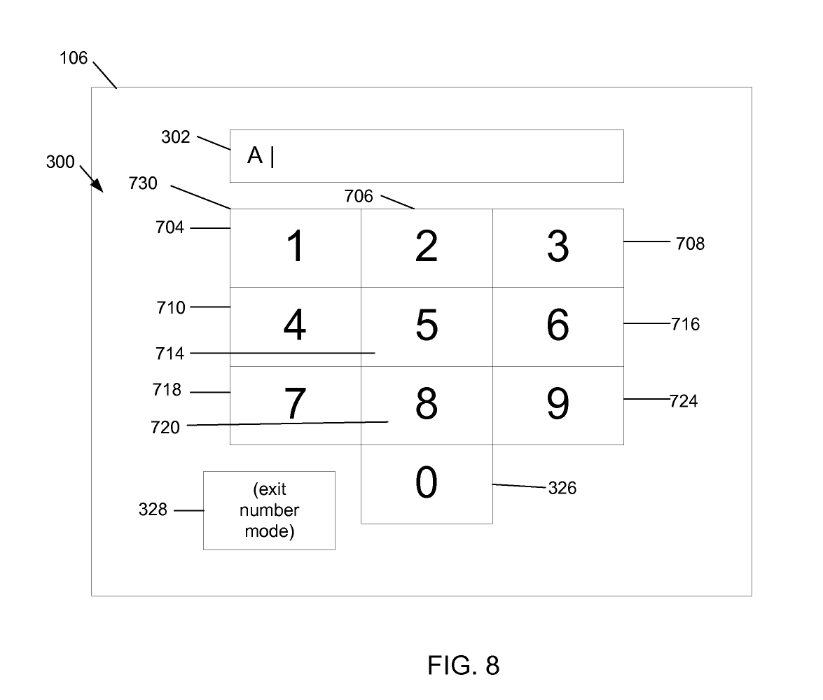

Referring now to FIG. 8, one of the function keys described on the example virtual keyboard 300 is the example number mode function key 324. This function key 324 causes the virtual on-screen keyboard 300 to be used for numerical entry, as shown in FIG. 8. The numbers “1” through “0” are shown in cells 704-726. Pressing a number key 1 through 0 on the remote control device causes the corresponding number to be displayed on display area 702. Each time the example number key on the remote control device that corresponds to number mode function key 524 is pressed, the mode toggles. For example, if the mode was number mode, toggling changes it to alphanumeric mode and if the mode was alphanumeric mode, toggling changes it to number mode.

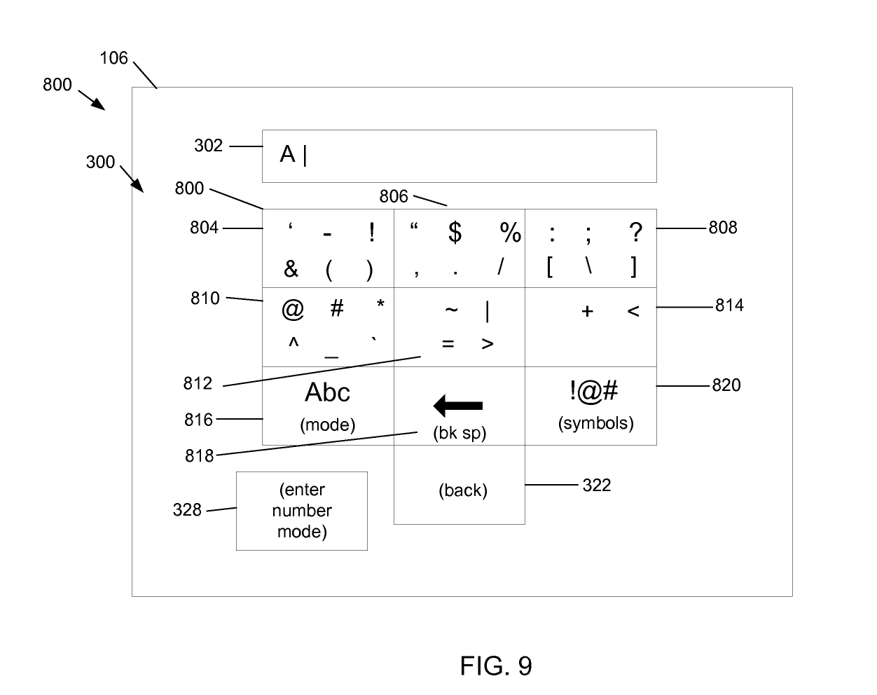

Referring now to FIG. 9, one of the cells on the example virtual keyboard 300 is the symbols key 320. Since the example symbols key 320 is the ninth cell on the virtual on-screen keyboard 300 going from left to right and top to bottom, it corresponds to number key 9 on the remote control device. For this example virtual on-screen keyboard 300, when the user enters the number 9 key on the remote control device, a grid 800 in FIG. 9 is shown. In the example grid 800, there are separate cells 804-814 for groups of symbols. In a similar manner to entering text, when a user enters a number key 1-6 on the remote control device, a corresponding grid is expanded and displayed. Then, when the user enters another number that corresponds to the position within the expanded grid, the symbol corresponding to that position is displayed on the display area 302.

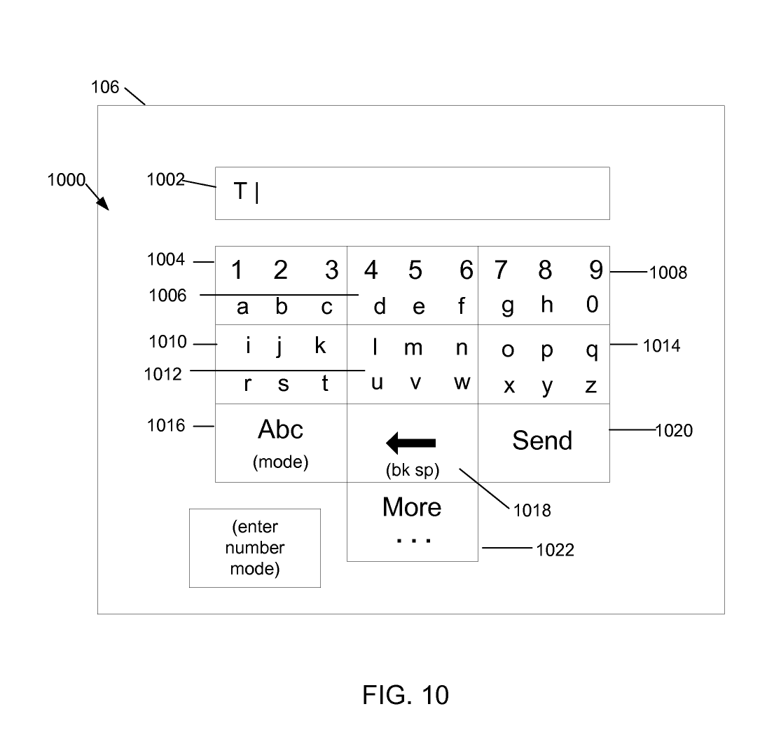

FIG. 10 shows another example grid 1000 for an embodiment of the present application that includes text messaging. In this embodiment, cells 1004-1014 containing alphanumeric characters that are used for text entry, and cells 1016-1022 are used for commands. Cells 1004-1014 correspond to number keys 0-6 on the remote control device, and cells 1016-1022 correspond to number keys 7-0 on the remote control device. Example commands that are specific to text entry can include a mode command 1016 for specifying initial capitals, all upper case or lower case entry, back space command 1018 for moving the cursor for display 1002 to the left, send command 1020 for sending the text message and more command 1022 which brings up additional command options.

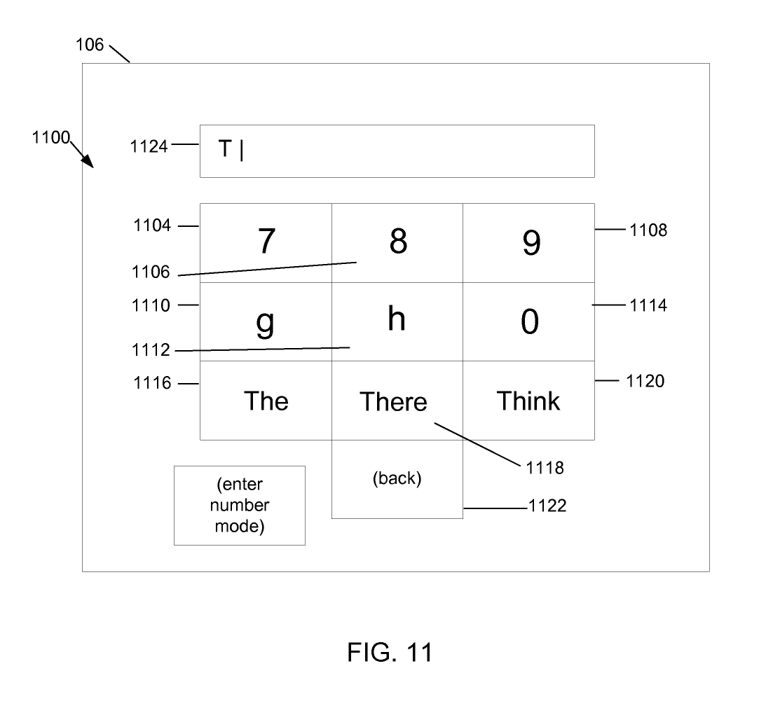

In this example, the letter “T” has been entered into display 1002. The user wishes to enter the word “There,” so the user presses number key 3 on the remote control device corresponding to cell 1008 which contains the letter “h.” This displays the example expanded grid 1100 shown in FIG. 11. The example grid 1100 shows the alphanumeric characters from cell 1008 expanded into separate cells 1104-1114. In this embodiment, the example grid 1100 shows that command cells 1116-1120 have been programmed to include predicted autocompletions for the word the user is trying to enter based on the partial entry “Th.” For example, cell 1116 includes the word “The,” cell 1118 includes the word “There,” and cell 1120 includes the word “Think.” In this example, cell 1122 is programmed to execute a “back” command to return to the previous screen.

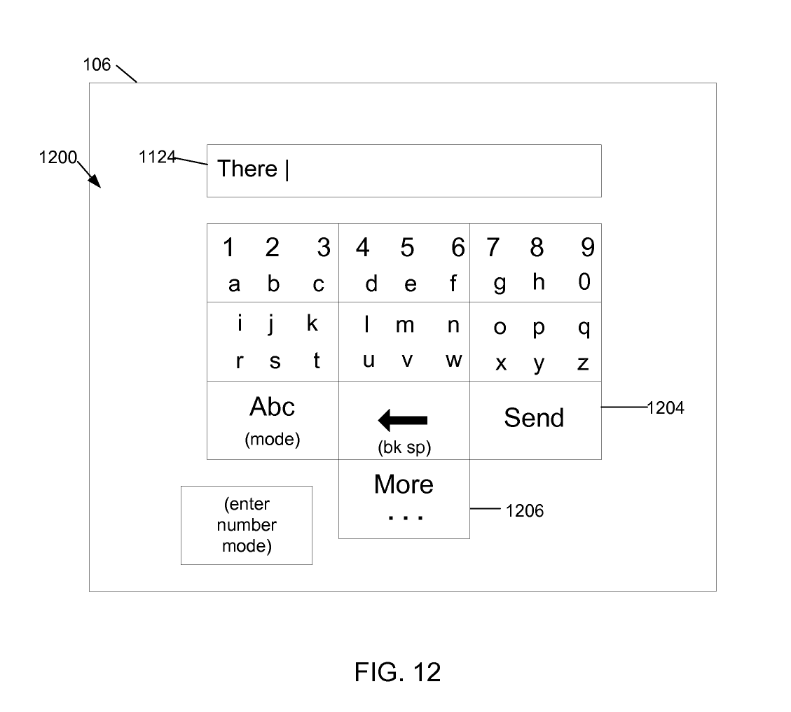

If the user now presses the 8 key on the remote control device, the word “There” corresponding to cell 1118 is entered into display 1124. This is shown in example grid 1200 in FIG. 12. Thus, by predicting example words that the user could enter, this embodiment reduces the number of keystrokes necessary to enter the word “There.”

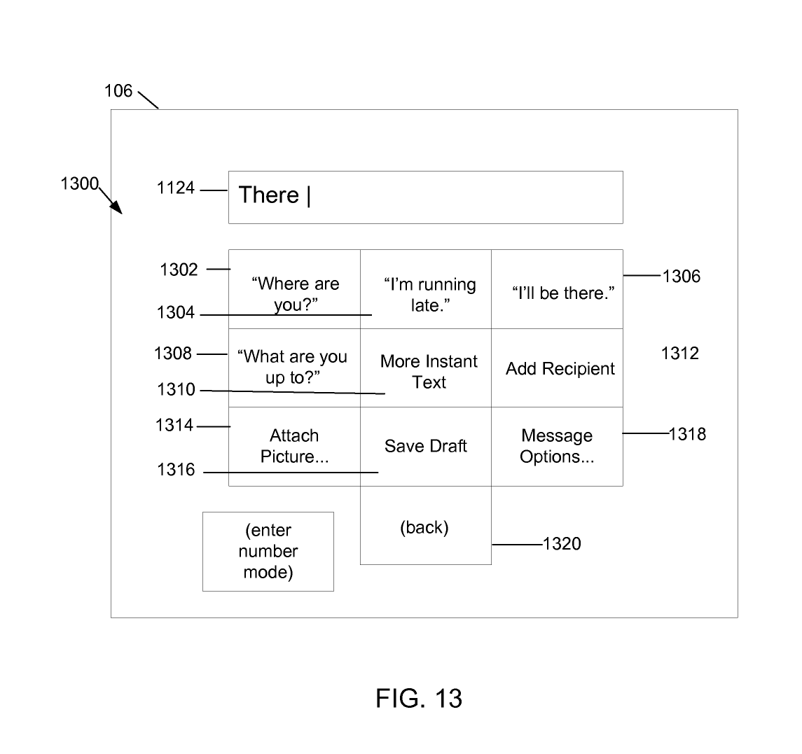

The example grid 1200 also shows that cell 1204 has been reprogrammed to include the word “Send” in preparation for the user sending the text message. In addition, cell 1206 has been reprogrammed to implement the “More” command for additional user options. For example, if the user wants to access additional commands associated with the message, the user presses the 0 key on the remote control device, corresponding to cell 1206, and the example grid 1300 shown in FIG. 13 is displayed.

In FIG. 13, the example grid 1300 shows that cells 1302-1320 have been reprogrammed again to include additional functions. For example, the user may choose to select one of the example phrases shown in cells 1302-1308. For more example phrases, the user can select cell 1310. Example cell 1312 is used to add a recipient, example cell 1314 to attach a picture to the text message, example cell 1316 to save a copy of the draft text message, example cell 1318 to display more text options and example cell 1320 to return to the previous screen.

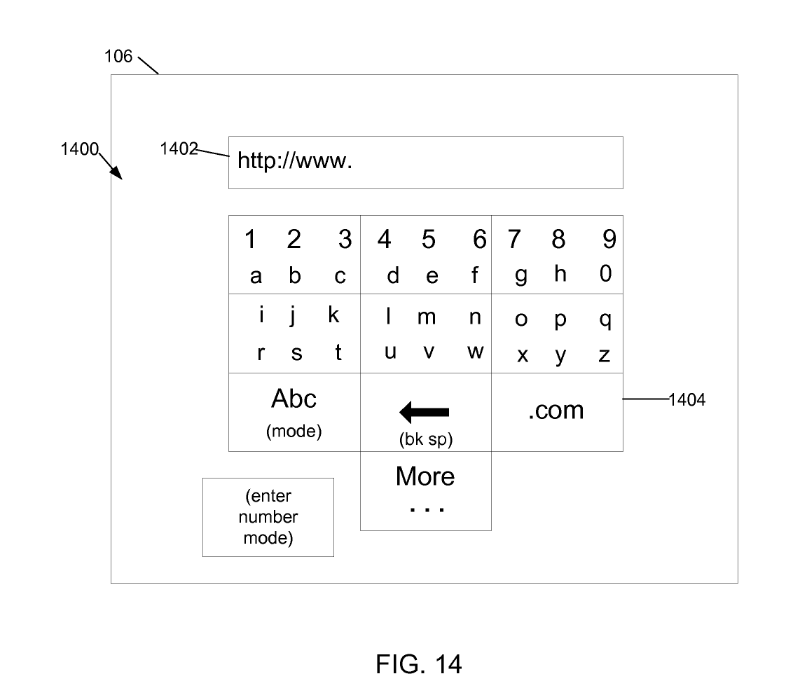

Referring now to FIG. 14, in another embodiment, the electronic device can be reprogrammed to input addresses such as uniform resource locators (“URLs”). An example grid 1400 illustrates this embodiment. For this embodiment, display area 1402 shows that the user has been entering an Internet address starting with “http//www.” Since Internet addresses typically end in “.com”, cell 1404 is reprogrammed to include “.com.” When the user has completed entering text for the Internet address, the user presses the 9 key on the remote control device, corresponding to cell 1404, and the text “.com” is added to the end of the Internet address in display area 1402. Other embodiments that include reprogramming the electronic device to implement additional functionality are possible.

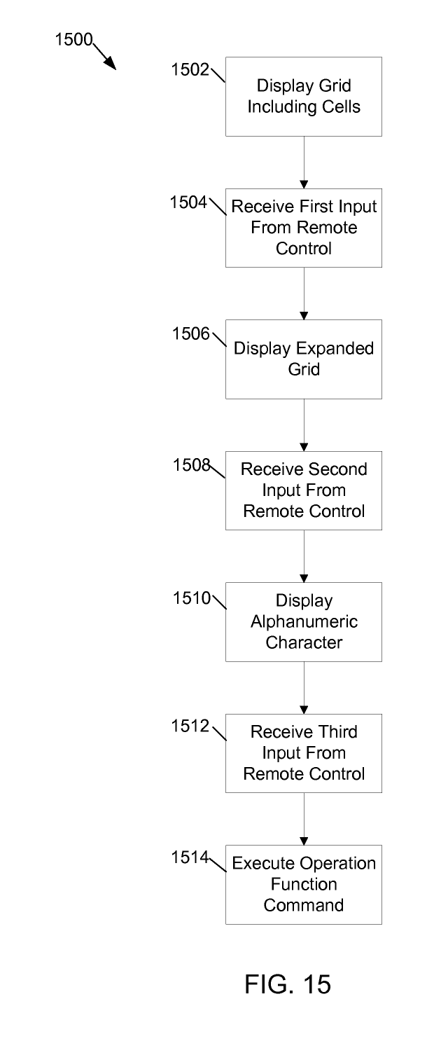

FIG. 15 is a flow chart showing an example method 1500 for inputting text to an electronic device using a remote control device. At operation 1502, the electronic device generates a grid with cells in the form of a virtual on-screen keyboard that is displayed on a display device. One or more cells include alphanumeric characters and at least one cell represents an operation function.

Next, at operation 1504, a user presses a numerical key on a remote control device that provides a first input to the electronic device. The first input selects a first cell including alphanumeric characters that contains a character the user wants to display. At operation 1506, the electronic device processes the first input and displays the first grid in a way that distinguishes the cell from the other cells on the virtual on-screen keyboard. Typically, this can be done by expanding the first cell so that each alphanumeric character in the cell is displayed in its own separate cell.

Next, at operation 1508, the user presses a number key on the remote control device corresponding to the position of the character to be displayed in the expanded first cell and provides a second input to the electronic device. At operation 1510, the electronic device processes the second input and displays the selected character on the display device.

The user can also input operational comments and other functions as well using the remote control and virtual on-screen keyboard. For example, at operation 1512, the user presses a number key on the remote control device corresponding to the position of an operation function cell on the virtual on-screen keypad, sending a third signal to the electronic device. At operation 1514, the electronic device executes the operation function command identified by the third signal.

The method described in FIG. 15 is only an example. In addition, text or commands may be entered independently of each other. For example, the user can enter a plurality of text and/or enter one or more function operations using the virtual keyboard.

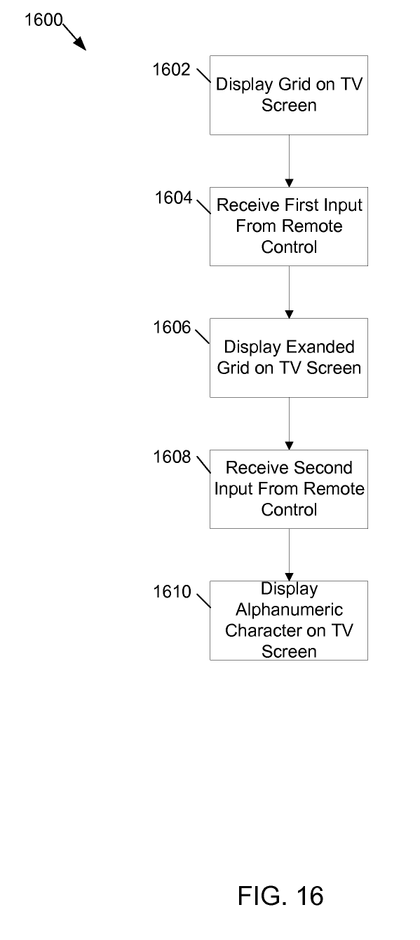

FIG. 16 is a flow chart showing an example method 1600 for inputting text to a set top box using a remote control device. At operation 1602, the set top box generates a grid in the form of a virtual on-screen keyboard that is displayed on a television display screen. In some examples, six cells include alphanumeric characters, and at least one cell represents an operation function.

Next, at operation 1604, a user presses a number key on a remote control device that provides a first input to the set top box. The first input selects a first cell including alphanumeric characters that contains a character the user wants to display. At operation 1606, the set top box processes the first input and displays the first grid on the television display screen in a way that distinguishes the selected cell from the other cells on the virtual on-screen keyboard. Typically this is done by expanding the selected cell so that each alphanumeric character in the cell is displayed in its own separate cell.

At operation 1608, the user presses a number key on the remote control device corresponding to the position of the character to be displayed in the first cell and provides a second input to the electronic device. At operation 1610, the set top box processes the second input and displays the selected character on the television display screen.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### BACKGROUND

Due to evolving television-based technologies, such as interactive television and web TV, there is an increased need to enter text into set top boxes or other electronic devices connected to television sets. The current method of text entry using remote control devices can be cumbersome. Typically, the user is presented with a virtual on-screen keyboard or an up/down scroll control in which the user can select letters via remote control to enter into a text box. These methods typically require an average of more than 5 keystrokes to enter a character.

Two current methods for text entry using a numeric keypad are multi-tap and T9. With multi-tap, a key corresponding to a character is pressed one or more times depending on the position of the character on the key. For example, on a typical phone keypad, the letters A, B, and C are associated with the 2 key. In order to enter the letter B, the 2 key is pressed two times because the letter B is the second letter in the A, B, C set.

With T9, a key associated with a letter is only pressed once. Then, as additional keys are pressed, the input device infers which letters are desired. For example, if the 8 key, 4 key and 3 key are pressed in succession, the device infers that the word “the” is to be entered. A second aspect of T9 is that as additional keys are pressed, the number of words corresponding to those key presses is reduced and the input device may provide a selection of words corresponding to those key presses. If the selection contains the word the user is trying to enter, the user can select the word with a single keystroke.

### SUMMARY

The present disclosure relates to systems and methods for inputting text and commands to an electronic device using a remote control device.

According to one aspect, a method for inputting text and commands to an electronic device using a remote control device includes: displaying a first grid on a display device, wherein at least one cell in the first grid represents alphanumeric characters and at least one cell represents an operation function; receiving a first input from the remote control device that identifies a first cell that includes first alphanumeric characters; displaying a second grid in front of the first grid such that the second grid including a plurality of cells, with each cell representing the first alphanumeric characters; receiving a second input from the remote control device that identifies a specific alphanumeric character within the second grid; and displaying the identified alphanumeric character on the display device.

According to another aspect, a method for inputting text and commands to a set top box using a remote control device includes: displaying a first grid on a television display screen, wherein six cells of the first grid include alphanumeric characters and at least one cell represents an operation function; receiving a first input from the remote control device that identifies a first cell of the first grid that includes first alphanumeric characters; displaying a second grid on the television display screen in front of the first grid such that the second grid including a plurality of cells, with each cell representing the first alphanumeric characters; receiving a second input from the remote control device that identifies a specific alphanumeric character within the second grid; displaying the specific alphanumeric character on the television display screen; receiving a third input from the remote control device that identifies an operation function; and executing the operation function identified by the third input.

According to yet another embodiment, an electronic device for inputting text and commands using a remote control device includes a virtual keyboard module programmed to display a virtual keyboard on a display device, the virtual keyboard including a first grid with at least some cells displaying a plurality of alphanumeric characters, and at least some cells display function operations. The electronic device includes a remote device input module programmed to receive input to the virtual keyboard from the remote control device. The electronic device also includes a text and operation output module programmed to, upon selection of a cell of the first grid: display a second grid including a plurality of cells each with one of a plurality of alphanumeric characters associated with the selected cell of the first grid; or execute an function operation associated with the selected cell of the first grid. The electronic device includes a memory module programmed to store the virtual keyboard module, the remote device input module, and the text and operation output module.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

The accompanying drawings incorporated in and forming a part of the specification illustrate several aspects of the present disclosure, and together with the description serve to explain the principles of the disclosure. In the drawings:

FIG. 1 shows an example system for entering text into an electronic device using a remote control device.

FIG. 2 shows an example keypad of the remote control device of FIG. 1.

FIG. 3 shows logical modules of the electronic device of FIG. 1.

FIG. 4 shows an example virtual on-screen keyboard that can be used when entering text into an electronic device.

FIG. 5 shows an example enlarged grid of a virtual on-screen keyboard that can be used when entering text into an electronic device.

FIG. 6 shows another example virtual on-screen keyboard that can be used when entering text into an electronic device.

FIG. 7 shows another example enlarged grid of a virtual on-screen keyboard that can be used when entering text into an electronic device.

FIG. 8 shows an example virtual on-screen keyboard that can be used when entering numerical data into an electronic device.

FIG. 9 shows an example virtual on-screen keyboard that can be used when entering symbols into an electronic device.

FIG. 10 shows an example virtual on-screen keyboard that can be used for text messaging.

FIG. 11 shows an example enlarged grid of a virtual on-screen keyboard that can be used when entering text during text messaging.

FIG. 12 shows another example virtual on-screen keyboard that can be used for text messaging.

FIG. 13 shows an example virtual on-screen keyboard that includes additional options for text messaging.

FIG. 14 shows an example virtual on-screen keyboard that can be used when entering addresses into an electronic device.

FIG. 15 shows a flow chart for an example method for entering text into an electronic device using a remote control device.

FIG. 16 shows a flow chart for an example method for entering text into a set top box using a remote control device.

### DETAILED DESCRIPTION

The present application is directed to systems and methods for entering text into an electronic device connected to a display device, such as a television screen, using a remote control device. The present application is also directed to entering operation function commands into an electronic device from a remote control device.

FIG. 1 shows an example system 100 for inputting text and commands into an electronic device using a remote control device. The example system 100 includes a remote control device 102, an electronic device 104, and a display device 106.

In example embodiments, the remote control device 102 is a device configured to control one or more of the electronic device 104 and the display device 106 using one or more wireless technologies. For example, the remote control device 102 can be a remote control that controls the electronic device 104 and/or the display device 106 using infrared, RF, or Bluetooth technologies. Other configurations are possible. For example, in other embodiments, the remote control device 102 can be connected to the electronic device 104 and/or the display device 106 using one or more wires.

The electronic device 104 is typically an electronic device that controls a display device, such as a television or computer monitor. For example, in some embodiments, the electronic device 104 is a cable or satellite TV set top box, a web TV box, a DVR or VCR, a digital picture frame, etc.

The display device 106 is typically a television screen, but it can be any display device, for example a computer monitor.

FIG. 2 shows an example an example keypad 200 of the remote control device 102. The example keypad 200 includes keys for the numbers 0-9. In some embodiments, the example keypad 200 also includes function keys, for example functions F1 and F2, and includes a directional pad with left, right, up, down arrow keys and an enter key. The function keys F1 and F2 may have the name of a function printed on the key—such as Enter. The user can push one or a combination of buttons on the keypad 200 to control one or both of the electronic device 104 and the display device 106. For example, the user can push number 0-9 to change channels displayed on the display device 106. The keypad 200 is one example of a remote control keypad. For example, some keyboards may not include function keys, and the functionality of such keys can instead be implemented as part of the user interface, as described further below. Many other configurations, including more keys and functionality, are possible.

Referring now to FIG. 3, the logical modules of the electronic device 104 are shown. The electronic device 104 includes a virtual keyboard module 352, a remote device input module 354, a text and operation output module 356, and a memory module 358.

The virtual keyboard module 352 is programmed to create a virtual keyboard on the display device 106. In example embodiments, the virtual keyboard can be used to allow users to input text and/or function operations to the electronic device 104 or the display device 106, as described further below.

The remote device input module 354 is programmed to receive input from the remote control 102. In example embodiments, the electronic device 104 is configured to receive an input signal from the remote control 102, and this signal is provided to the remote device input module 354. In other examples, the display device 106 is configured to receive an input signal from the remote control 102, and this signal is provided to the remote device input module 354. Other configurations are possible.

The text and operation output module 356 is programmed to display text and/or perform function operations based on the input received by the remote device input module 354. For example, the text and operation output module 356 can be programmed to display text on the display device 106 based on the input received by the remote device input module 354. In addition, the text and operation output module 356 can be programmed to perform function operations based on the input received by the remote device input module 354, as described further below.

The memory module 358 is programmed to store data, such as the virtual keyboard module 352, the remote device input module 354, and the text and operation output module 356. In example embodiments, the memory module 358 is a computer readable media. Computer readable media can be any available media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, BC-ROM, digital versatile disks (DVD) or other optical storage, magnetic cassettes, magnetic tape, magnetic disk storage or other magnetic storage devices, or any other medium which can be used to store the desired information. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Referring now to FIG. 4, when text is inputted to an example electronic device using example system 100, the user is presented with a virtual on-screen keyboard 300 on the display device 106 that is used in conjunction with remote control device 102 for text and command entry.

In the example shown, the keyboard 300 includes a virtual on-screen keypad 330. The virtual on-screen keypad 330 is arranged as a grid with each cell in the grid associated with a number key on the remote control device 104. Included in the example virtual on-screen keyboard 330 are cells representing alphanumeric keys 304-314, symbols key 320 and function keys 316, 318, 322 and 324. Also included on example keyboard 330 is an example display area 302 that displays the characters selected.

In the example shown, each of the six example alphanumeric keys 304-314 includes six alphanumeric characters. For example, alphanumeric key 304 includes the numbers “1, 2, 3” and the letters “A, B, C.” The example symbols key 324 is identified by example symbols “!@#” and is used to enter punctuation and other symbols.

The example function keys 316, 318, 322 and 324 are identified by a specific operation function. Generally, the function keys are programmed to provide additional functionality to the input to the electronic device 104 or the display 106.

For example, example function key 316 selects a text entry mode, either upper case for the initial letter of a word and lower case for the remaining characters in the word, or all upper case or all lower case. Example function key 318 is used for a backspace function. Example function key 320 is used to select a numerical mode for text entry and example function key 322 is used to go back to the previous operation.

In other examples, one or more of the function keys can be used to provide auto completion or predictive text capabilities. For example, as the user inputs characters, completed words or phrases can be provided in the cells associated with the function keys so that the user can select a desired word or phrase to optimize the efficiency of text input. Other examples include using one or more of the function keys for text messaging or for entering HTML settings into the device, as described further below. It will be understood that the number and type of function keys shown on the keyboard 300 are just examples. Many other configurations are possible.

As shown in FIG. 4, the six example alphanumeric keys 304-316 correspond to the number keys 1-6 on a remote control device. For example, number key 1 on the remote control device corresponds to alphanumeric key 304, number key 2 corresponds to alphanumeric key 306, number key 3 corresponds to alphanumeric key 308, etc. going from left to right, top to bottom so that number key 6 corresponds to alphanumeric key 314. For example, if a user wanted to enter the letter A, the user would press number key 1 on the remote control because it corresponds to the cell 304 that includes the letter “A.”

Referring now to FIG. 5, when a user presses a key on the remote control device 102 corresponding to one of cells 304-314 (i.e. one of the cells representing alphanumeric characters), the selected cell expands to display the alphanumeric characters in a separate grid. For example, when the user presses number key 1 on the remote control, the cell displaying alphanumeric key 304 expands to a grid 400 that overlays the keyboard 300. As shown in FIG. 5, each alphanumeric character from cell 304 is displayed in a separate cell 402-412 in the grid 400. Thus, the number 1 is displayed in cell 402 and the letter A is displayed in cell 408, etc.

The six example cells 402-412 shown in FIG. 5 are associated with number keys 1-6 on the remote control device. Going from left to right and top to bottom, number key 1 corresponds to cell 402, number key 2 corresponds to cell 404, number key 5 corresponds to cell 410, etc.

Therefore, when the expanded cells 402-412 are displayed, number key 1 on the remote control is pressed to select the number 1 in cell 402, number key 5 is pressed on the remote control to select the letter B in cell 410, etc. Thus, entering text is a two-step process. First, a cell corresponding to an alphanumeric key on the virtual on-screen keyboard is selected by pressing the remote control key associated with that cell. Then, when the cell expands to display another grid, as shown in FIG. 5, the specific alphanumeric character is selected by pressing the remote control number key associated with the expanded grid that displays the character. The cell expansion can make it easier for the user to see and select the desired character.

Referring again to FIG. 4, the example function keys 316 and 318, the example symbol key 320, and the example function key 322 correspond to remote control keys 7, 8, 9 and 0, respectively. In addition, example function key 324 corresponds to a specific function key on the remote control device (for example F1 or F2 shown in FIG. 2). So, for example, pressing number key 7 on the remote control device provides a command to execute the Abc mode command operation function 316. A typical way in which this command works is to toggle between three capitalization modes as discussed above. For example, pressing number key 7 once changes the mode to all lower case, pressing key 7 a second time changes the mode to all upper case and pressing key 7 a third time changes the mode to upper case for the initial character in a word and lower case for the remaining characters in the word. In some embodiments, the electronic device 104 causes the appearance of the operation function key to change to “abc,” “ABC,” and “Abc” for the three successive presses of number key 7.

Similarly, pressing number key “8” on the remote control device provides a command to an example back space function 318 and causes display 302 to backspace one position. Pressing number key “9” activates an example symbol key 320 and permits the user to enter a symbol. Pressing number key “0” on the remote control activates an example back function key 322 and causes electronic device 104 to go back to the previous operation. Function key 324 (for entering number mode) is associated with a function key (e.g. F1 or F2 in FIG. 2) on the remote control device.

Still referring to FIG. 4, in some embodiments, the cells associated with remote control device keys “7, 8, 9, 0” (corresponding to cells 316-322) are program specific and can be programmed by the electronic device 104 to represent different functions than those shown in FIG. 4. In some embodiments, the operation function cells can be programmed based on user selections. For example, in one embodiment, the user can program frequently-used phrases so that the phrases are displayed using the auto-complete feature, as described herein. Other embodiments that make use of user programmable features include text messaging and entering HTML settings.

FIG. 6 shows how the keyboard 300 might look after the letter A has been entered. In this example, the display area 302 shows the letter “A.” Also, because the mode function key 316 indicates the mode as Abc, meaning an upper case letter for the first character in a word and lower case characters for the remaining characters in the word, the alphanumeric keys 304-314 are shown with lower case letters. In this example, the function keys 316, 318, 322 and 324 and the symbol key 320 have not changed.

If a user now wants to enter the letter t, the user presses the number key 4 on the remote control device, since this corresponds to the cell on the keyboard 300 that includes the letters “i, j, k, r, s, t.” When the user enters the number key 4 on the remote control device, the cell containing these letters is expanded, as shown in FIG. 7. Each letter is now displayed in a separate cell 604-614 that corresponds to number keys 1-6 on the remote control device. If the user now presses number key 6 on the remote control device, the letter “t” is selected for display, since the letter “t” is the sixth alphabetic character cell shown in FIG. 7 going from left to right and top to bottom.

Referring now to FIG. 8, one of the function keys described on the example virtual keyboard 300 is the example number mode function key 324. This function key 324 causes the virtual on-screen keyboard 300 to be used for numerical entry, as shown in FIG. 8. The numbers “1” through “0” are shown in cells 704-726. Pressing a number key 1 through 0 on the remote control device causes the corresponding number to be displayed on display area 702. Each time the example number key on the remote control device that corresponds to number mode function key 524 is pressed, the mode toggles. For example, if the mode was number mode, toggling changes it to alphanumeric mode and if the mode was alphanumeric mode, toggling changes it to number mode.

Referring now to FIG. 9, one of the cells on the example virtual keyboard 300 is the symbols key 320. Since the example symbols key 320 is the ninth cell on the virtual on-screen keyboard 300 going from left to right and top to bottom, it corresponds to number key 9 on the remote control device. For this example virtual on-screen keyboard 300, when the user enters the number 9 key on the remote control device, a grid 800 in FIG. 9 is shown. In the example grid 800, there are separate cells 804-814 for groups of symbols. In a similar manner to entering text, when a user enters a number key 1-6 on the remote control device, a corresponding grid is expanded and displayed. Then, when the user enters another number that corresponds to the position within the expanded grid, the symbol corresponding to that position is displayed on the display area 302.

FIG. 10 shows another example grid 1000 for an embodiment of the present application that includes text messaging. In this embodiment, cells 1004-1014 containing alphanumeric characters that are used for text entry, and cells 1016-1022 are used for commands. Cells 1004-1014 correspond to number keys 1-6 on the remote control device, and cells 1016-1022 correspond to number keys 7-0 on the remote control device. Example commands that are specific to text entry can include a mode command 1016 for specifying initial capitals, all upper case or lower case entry, back space command 1018 for moving the cursor for display 1002 to the left, send command 1020 for sending the text message and more command 1022 which brings up additional command options.

In this example, the letter “T” has been entered into display 1002. The user wishes to enter the word “There,” so the user presses number key 3 on the remote control device corresponding to cell 1008 which contains the letter “h.” This displays the example expanded grid 1100 shown in FIG. 11. The example grid 1100 shows the alphanumeric characters from cell 1008 expanded into separate cells 1104-1114. In this embodiment, the example grid 1100 shows that command cells 1116-1120 have been programmed to include predicted autocompletions for the word the user is trying to enter based on the partial entry “Th.” For example, cell 1116 includes the word “The,” cell 1118 includes the word “There,” and cell 1120 includes the word “Think.” In this example, cell 1122 is programmed to execute a “back” command to return to the previous screen.

If the user now presses the 8 key on the remote control device, the word “There” corresponding to cell 1118 is entered into display 1124. This is shown in example grid 1200 in FIG. 12. Thus, by predicting example words that the user could enter, this embodiment reduces the number of keystrokes necessary to enter the word “There.”

The example grid 1200 also shows that cell 1204 has been reprogrammed to include the word “Send” in preparation for the user sending the text message. In addition, cell 1206 has been reprogrammed to implement the “More” command for additional user options. For example, if the user wants to access additional commands associated with the message, the user presses the 0 key on the remote control device, corresponding to cell 1206, and the example grid 1300 shown in FIG. 13 is displayed.

In FIG. 13, the example grid 1300 shows that cells 1302-1320 have been reprogrammed again to include additional functions. For example, the user may choose to select one of the example phrases shown in cells 1302-1308. For more example phrases, the user can select cell 1310. Example cell 1312 is used to add a recipient, example cell 1314 to attach a picture to the text message, example cell 1316 to save a copy of the draft text message, example cell 1318 to display more text options and example cell 1320 to return to the previous screen.

Referring now to FIG. 14, in another embodiment, the electronic device can be reprogrammed to input addresses such as uniform resource locators (“URLs”). An example grid 1400 illustrates this embodiment. For this embodiment, display area 1402 shows that the user has been entering an Internet address starting with “http//:www.” Since Internet addresses typically end in “.com”, cell 1404 is reprogrammed to include “.com.” When the user has completed entering text for the Internet address, the user presses the 9 key on the remote control device, corresponding to cell 1404, and the text “.com” is added to the end of the Internet address in display area 1402. Other embodiments that include reprogramming the electronic device to implement additional functionality are possible.

FIG. 15 is a flow chart showing an example method 1500 for inputting text to an electronic device using a remote control device. At operation 1502, the electronic device generates a grid with cells in the form of a virtual on-screen keyboard that is displayed on a display device. One or more cells include alphanumeric characters and at least one cell represents an operation function.

Next, at operation 1504, a user presses a numerical key on a remote control device that provides a first input to the electronic device. The first input selects a first cell including alphanumeric characters that contains a character the user wants to display. At operation 1506, the electronic device processes the first input and displays the first grid in a way that distinguishes the cell from the other cells on the virtual on-screen keyboard. Typically, this can be done by expanding the first cell so that each alphanumeric character in the cell is displayed in its own separate cell.

Next, at operation 1508, the user presses a number key on the remote control device corresponding to the position of the character to be displayed in the expanded first cell and provides a second input to the electronic device. At operation 1510, the electronic device processes the second input and displays the selected character on the display device.

The user can also input operational comments and other functions as well using the remote control and virtual on-screen keyboard. For example, at operation 1512, the user presses a number key on the remote control device corresponding to the position of an operation function cell on the virtual on-screen keypad, sending a third signal to the electronic device. At operation 1514, the electronic device executes the operation function command identified by the third signal.

The method described in FIG. 15 is only an example. In addition, text or commands may be entered independently of each other. For example, the user can enter a plurality of text and/or enter one or more function operations using the virtual keyboard.

FIG. 16 is a flow chart showing an example method 1600 for inputting text to a set top box using a remote control device. At operation 1602, the set top box generates a grid in the form of a virtual on-screen keyboard that is displayed on a television display screen. In some examples, six cells include alphanumeric characters, and at least one cell represents an operation function.

Next, at operation 1604, a user presses a number key on a remote control device that provides a first input to the set top box. The first input selects a first cell including alphanumeric characters that contains a character the user wants to display. At operation 1606, the set top box processes the first input and displays the first grid on the television display screen in a way that distinguishes the selected cell from the other cells on the virtual on-screen keyboard. Typically this is done by expanding the selected cell so that each alphanumeric character in the cell is displayed in its own separate cell.

At operation 1608, the user presses a number key on the remote control device corresponding to the position of the character to be displayed in the first cell and provides a second input to the electronic device. At operation 1610, the set top box processes the second input and displays the selected character on the television display screen.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for inputting text and commands to an electronic device using a remote control device, the method comprising:
displaying a first grid on a display device, wherein at least one cell in the first grid represents alphanumeric characters and at least one cell represents an operation function;
receiving a first input from the remote control device that identifies a first cell that may include first alphanumeric characters;
displaying a second grid in front of the first grid such that the second grid including a plurality of cells, with each cell representing the first alphanumeric characters;
receiving a second input from the remote control device that identifies a specific alphanumeric character within the second grid; and
displaying the identified alphanumeric character on the display device.

2. The method of claim 1, further comprising:
receiving a third input from the remote control device that identifies an operation function; and
executing the operation function identified by the third input.

3. The method of claim 1, wherein six cells of the first grid include alphanumeric characters.

4. The method of claim 3, wherein at least one of the cells of the first grid includes operation functions.

5. The method of claim 4, wherein the operation function is selected from the group consisting of: a mode command, a number mode selector, a backspace key, and a navigation key.

6. The method of claim 1, wherein at least one of the cells of the first grid includes operation functions.

7. The method of claim 6, wherein the operation function is selected from the group consisting of: a mode command, a number mode selector, a backspace key, and a navigation key.

8. The method of claim 1, further comprising displaying each of ten numerical characters in a separate cell when a number mode selector is selected.

9. The method of claim 1, further comprising at least one cell that includes symbols.

10. The method of claim 1, wherein at least one cell of the first grid represents an operation function that is user programmable.

11. The method of claim 1, wherein at least one cell of the first grid automatically displays a selection of alphabetic characters that completes a word when an identified alphanumeric character in the first grid is displayed.

12. A method for inputting text and commands to a set top box using a remote control device, the method comprising:
displaying a first grid on a television display screen, wherein six cells of the first grid include alphanumeric characters and at least one cell represents an operation function;
receiving a first input from the remote control device that identifies a first cell of the first grid that includes first alphanumeric characters;
displaying a second grid on the television display screen in front of the first grid such that the second grid including a plurality of cells, with each cell representing the first alphanumeric characters;
receiving a second input from the remote control device that identifies a specific alphanumeric character within the second grid;
displaying the specific alphanumeric character on the television display screen;
receiving a third input from the remote control device that identifies an operation function; and
executing the operation function identified by the third input.

13. The method of claim 12, wherein the operation function is selected from the group consisting of: a mode command, a backspace key, and a navigation key.

14. The method of claim 12, wherein at least one cell of the first grid represents an operation function that is user programmable.

15. The method of claim 12, wherein at least one cell of the first grid automatically displays a selection of alphabetic characters that completes a word when an identified alphanumeric character in the first grid is displayed.

16. An electronic device for inputting text and commands using a remote control device, the electronic device comprising:
a virtual keyboard module programmed to display a virtual keyboard on a display device, the virtual keyboard including a first grid with at least some cells displaying a plurality of alphanumeric characters, and at least some cells display function operations;
a remote device input module programmed to receive input to the virtual keyboard from the remote control device;
a text and operation output module programmed to, upon selection of a cell of the first grid:
display a second grid including a plurality of cells each with one of a plurality of alphanumeric characters associated with the selected cell of the first grid; or
execute a function operation associated with the selected cell of the first grid; and
a memory module programmed to store the virtual keyboard module, the remote device input module, and the text and operation output module.

17. The electronic device of claim 16, wherein each of six cells the first grid include six alphanumeric characters.

18. The electronic device of claim 16, wherein the operation function is selected from the group consisting of: a mode command, a backspace key, and a navigation key.

19. The electronic device of claim 16, wherein the operation function is user programmable.

20. The electronic device of claim 16, wherein the text and operation output module is further programmed to include at least one cell of the first grid that automatically displays a selection of alphabetic characters that completes a word when an identified alphanumeric character in the first grid is displayed.
